(19) United States
(12) Patent Application Publication
(10) Pub. No.: US 2013/0262987 A1
(43) Pub. Date: Oct. 3, 2013

(54) DOCUMENT PROCESSING METHOD, APPARATUS AND EDITOR

(71) Applicant: HUAWEI TECHNOLOGIES CO., LTD., Shenzhen (CN)

(72) Inventors: Wenfang Tang, Shenzhen (CN); Weidong Liu, Shenzhen (CN)

(73) Assignee: Huawei Technologies Co., Ltd., Shenzhen (CN)

(21) Appl. No.: 13/685,272

(22) Filed: Nov. 26, 2012

(30) Foreign Application Priority Data
Mar. 29, 2012 (CN) 201210088089.2

(51) Int. Cl. G06F 17/22

(52) U.S. Cl. CPC G06F 17/2247
USPC 715/239

(57) ABSTRACT

Embodiments of the present invention disclose a document processing method and apparatus. The method includes: obtaining an initial document; converting the initial document and forming a target extensible application markup language XAML document, where the target XAML document at least includes a basic content and an extended content, and the extended content has a plurality of user-defined attribute tags. By adopting the present invention, attribute marking may be performed according to the document content, and the document content may be correspondingly displayed according to an attribute tag. Therefore, the document content can be viewed in a filtered manner according to an attribute type, and the effect of “what you see is what you get” is achieved in a text editing display interface.

### CROSS-REFERENCE TO RELATED APPLICATION

This application claims priority to Chinese Patent Application No. 201210088089.2, filed on Mar. 29, 2012, which is hereby incorporated by reference in its entirety.

### FIELD OF THE INVENTION

The present invention relates to the computer processing field, and in particular, to a document processing method, apparatus, and editor.

### BACKGROUND OF THE INVENTION

In product development, to meet the demands for supporting product bidding and launching, engineering installation and testing, office routine maintenance, and customer and cooperation partner training, an information document relevant to a product is synchronously developed.

Taking a certain information document of a product as an example, before the product is released, for different dimensions, such as a customer, a format, and a platform, this information document is saved as different duplicates for synchronous maintenance. However, these duplicate documents are essentially derived from one document, so that a plurality of duplicate documents needs to be manually maintained in the entire development process of the product, and the method results in low efficiency and a high cost, and is prone to errors and omissions.

In the conventional art, after bringing up an “application configuration file” window by clicking on a three-level menu “application configuration file” under “edit” in a menu bar, the attribute of the content of a current tag pair may be set.

However, the part with the set attribute is not easy to identify, and the user perception is poor. For example, attribute information of an ordinary document content (for example, a title, a paragraph, a table, and an image) is all demonstrated in the form of a tag pair. Different types of attributes set to meet different requirements are thereby submerged in basic attributes of the document, which makes it difficult for a user to rapidly identify which parts are set with the above required attributes and what are the values of the required attributes.

Meanwhile, when setting the above required attributes, an attribute cannot be set for an arbitrary part of the document. The attribute setting can only be customized with the tag pair as the smallest dimension according to a hypertext markup language (Hypertext Markup Language, HTML) or an extensible markup language (Extensible Markup Language, XML) tag.

This makes it impossible to view the document content in a filtered manner according to the set attributes, and the effect of “what you see is what you get” is not achieved in a text editing display interface.

### SUMMARY OF THE INVENTION

To solve the foregoing technical problems, embodiments of the present invention provide a document processing method, apparatus and editor, to perform user-defined attribute marking on a part of a document content, and correspondingly display the document content according to a user-defined attribute tag. Therefore, the document content can be viewed in a filtered manner according to the attribute tag, and the effect of “what you see is what you get” is achieved in a text editing display interface.

In order to solve the foregoing technical problems, in one aspect, an embodiment of the present invention provides a document processing method, which includes:

obtaining an initial document; and

converting the initial document and forming a target extensible application markup language XAML document, where the target XAML document at least includes a basic content and an extended content, and the extended content has a plurality of user-defined attribute tags.

In another aspect, an embodiment of the present invention also provides a document processing apparatus, which includes:

an initial document obtaining unit, configured to obtain an initial document; and

a converting unit, configured to convert the initial document into a target XAML document, where the target XAML document at least includes a basic content and an extended content, and the extended content has a plurality of user-defined attribute tags.

In another aspect, an embodiment of the present invention also provides a document editor, which includes a memory and a processor, where the memory is configured to store an initial document; and

the processor is configured to obtain the initial document, convert the initial document into a target XAML document, and store the target XAML document in the memory, where the target XAML document at least includes a basic content and an extended content, and the extended content has a plurality of user-defined attribute tags.

The embodiments of the present invention bring the following benefits:

A document is processed after being converted into a document of an XAML format, and attribute marking may be performed on a part of the content in the XAML document. During display, the content in the document may be filtered and displayed according to an attribute tag, thereby achieving the display effect of “what you see is what you get”.

### BRIEF DESCRIPTION OF THE DRAWINGS

To illustrate the technical solutions according to the embodiments of the present invention or in the conventional art more clearly, the accompanying drawings required for describing the embodiments or the conventional art are introduced in the following briefly. Apparently, the accompanying drawings in the following descriptions merely show some of the embodiments of the present invention, and persons of ordinary skill in the art can obtain other drawings according to the accompanying drawings without any creative efforts.

FIG. 1 is a specific schematic flowchart of a document processing method according to an embodiment of the present invention;

FIG. 2 is another specific schematic flowchart of a document processing method according to an embodiment of the present invention;

FIG. 3 is a schematic diagram of a specific interface of performing marking in a visual editor according to an embodiment of the present invention;

FIG. 4 is a schematic diagram of an interface effect of simultaneously displaying each attribute tag and document contents after performing attribute marking on different contents of an XAML document according to an embodiment of the present invention;

FIG. 5 is a schematic diagram of an interface effect of simultaneously displaying an “Expert attribute” and document contents after performing attribute marking on different contents of an XAML document according to an embodiment of the present invention;

FIG. 6 is a specific schematic flowchart of a document editing method according to an embodiment of the present invention;

FIG. 7 is a specific schematic composition diagram of a document processing apparatus according to an embodiment of the present invention;

FIG. 8 is a specific schematic composition diagram of a converting unit according to an embodiment of the present invention;

FIG. 9 is a specific schematic composition diagram of a document editor according to an embodiment of the present invention; and

FIG. 10 is a schematic indicator diagram of a starting graphic and an ending graphic of a document content with an attribute tag in FIG. 4.

### DETAILED DESCRIPTION OF THE EMBODIMENTS

The technical solutions of the embodiments of the present invention are hereinafter described clearly and completely with reference to the accompanying drawings in the embodiments of the present invention. Evidently, the described embodiments are only some embodiments of the present invention, rather than all embodiments of the present invention. All other embodiments, which can be derived by persons of ordinary skill in the art from the embodiments given herein without any creative effort, shall fall within the protection scope of the present invention.

In the embodiments of the present invention, an XML file is converted into an extensible application markup language (eXtensible Application Markup Language, XAML) file, so as to visually demonstrate the XML file in an editor. Then, XAML documents are marked with different attribute tags, and is finally displayed according to attributes of the tags, so as to achieve the editing effect of “what you see is what you get”.

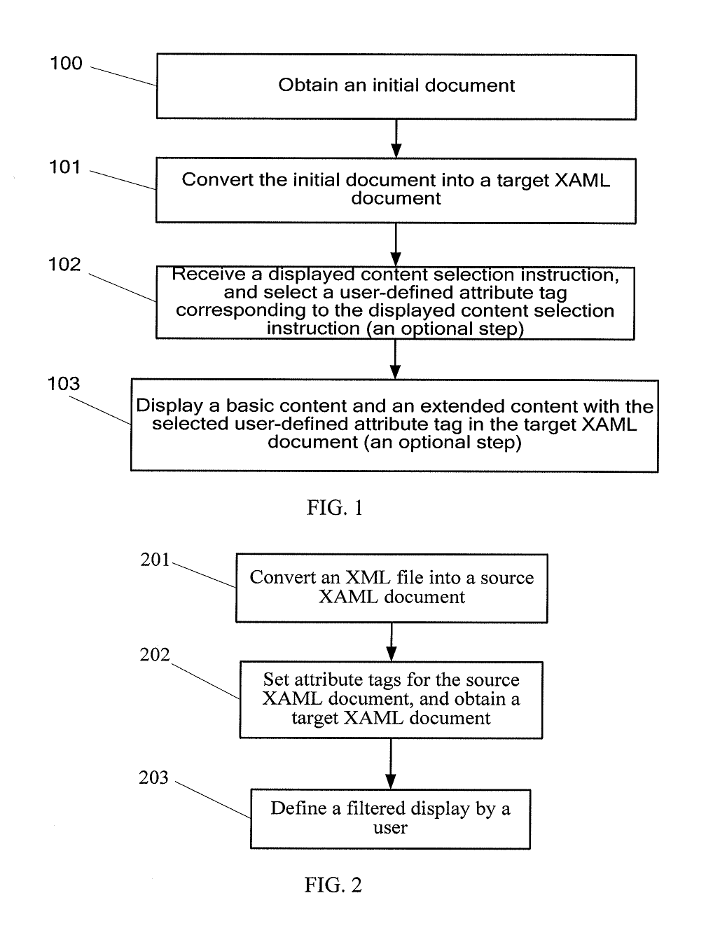

As shown in FIG. 1, it is a specific schematic flowchart of a document processing method according to an embodiment of the present invention, which includes the following steps.

100: Obtain an initial document. The initial document may be a Darwin information typing architecture (Darwin Information Typing Architecture, DITA) standard document, an OpenXML standard document, an open document format (Open Document Format, ODF) standard document, or a user-defined standard document. Before this step, the method may also include a step of converting an XML document into an initial document.

101: Convert the initial document into a target XAML document, where the target XAML document at least includes a basic content and an extended content, and the extended content has a plurality of user-defined attribute tags. The user-defined attribute tags carried in the same target XAML document may be the same tags, and may also be different tags. The same content may carry one attribute tag, and may also carry two or more different attribute tags.

This step may specifically include the following steps. X: Convert the initial document to form a source XAML document. Y: Receive a content selection instruction and obtain a content attribute tag assignment instruction, select a content of the source XAML document according to the content selection instruction, and according to the content attribute tag assignment instruction, assign user-defined attribute tags to the selected content of the source XAML document to construct the target XAML document, where the user-defined attribute tags are used to mark attributes of the extended content, the selected content of the target XAML document, to which the user-defined attribute tags are assigned, is taken as the extended content, and the rest content is taken as the basic content.

During storing, the user-defined attribute tags are not stored in the source XAML document. In this way, the user-defined attribute tags may not occupy placeholders of the source XAML document. Further, during displaying, the target XMAL document includes a content displaying layer and an attribute displaying layer, where the content displaying layer only displays the basic content and the extended content, and the attribute displaying layer only displays the user-defined attribute tags. The user-defined attribute tags do not occupy the placeholders of the source XAML document. In this way, in a subsequent displaying step, the content of the source XAML document and the attribute tag of the source XAML document may be displayed on a different layer.

Meanwhile, this step may also include: A: Generate a selection box of selectable content attribute tags according to a plurality of preset content attribute tags, and display the plurality of preset content attribute tags in the selection box of content attribute tags. If marking is performed in step A, after step A, according to the action of selecting attribute tags in the selection box by a user, a content attribute tag selection instruction may be generated, then the content attribute tag selection instruction may be received, and according to the content attribute tag selection instruction, content attribute tags corresponding to the content attribute tag selection instruction are obtained to generate the content attribute tag assignment instruction. In this way, the content attribute tag assignment instruction may be obtained in step Y to assign content attribute tags to the document content.

When the plurality of preset content attribute tags is displayed in the selection box of content attribute tags, the plurality of preset content attribute tags may be presented in the selection box of content attribute tags in a hierarchical architecture manner. This selection box may be a single-choice selection box, and may also be a multiple-choice selection box.

102: Receive a displayed content selection instruction, and according to a user-defined attribute tag selected according to the displayed content selection instruction, obtain an extended content with the selected user-defined attribute tag (this step is an optional step). It should be noted that the user-defined attribute tag corresponding to the instruction in this step may be a user-defined attribute tag selected by the user in a document editor, and is different from the user-defined attribute tag obtained when the target XAML document is generated. When the document is generated, the user defines an attribute tag for the document, and the document editor obtains the tag. When the document is displayed in a filtered manner, the user selects, from the document, a user-defined attribute tag of the document, and the document editor obtains the tag.

103: Display the basic content and the extended content with the selected user-defined attribute tag in the target XAML document (this step is an optional step).

Specifically, during displaying, the content carrying the user-defined attribute tag and the user-defined attribute tag corresponding to the content may be displayed simultaneously, and the user-defined attribute tag may be displayed near the content in the form of a tag. In order to make the user-defined attribute tag not occupy the placeholder of the document, the attribute tag may be displayed independent of the source document content in the form of a layer. That is, the source XAML document is displayed on a document layer, and the user-defined attribute tag is displayed on a tag layer. Since the same target document may have a plurality of different user-defined attribute tags, the different user-defined attribute tags may be displayed on different tag layers.

Further, in this step, when the user-defined attribute tag is displayed, the content with the user-defined attribute tag in the document may be distinguished from another content of the document through a specific graphic tag. For example, a starting graphic image and an ending graphic image (or referred to as graphic tags) are added before and after the content with the user-defined attribute tag. In this way, it is easy to distinguish the content with the user-defined attribute tag from another content of the document. During the specific displaying, graphic images for limiting a range and the user-defined attribute tag may be displayed in the form of a layer, and displayed on a layer different from that of the source document, so that the placeholders of the document are not occupied.

Optionally, this embodiment may also include step 104 of concealing the user-defined attribute tag of the extended content; or include step 105 of fixing document formats of the basic content and the extended content with the selected user-defined attribute tag in the target XAML document.

That is, during displaying, the user-defined attribute tag may be concealed, and meanwhile, the displayed content with the obtained user-defined attribute tag and the displayed content with no user-defined attribute tag in the target XAML document may be released as the document of a fixed format, for example, a Word document (a document processed by the Microsoft Word, a word processing application of the Microsoft Corporation), a portable document format (Portable Document Format, PDF) document, and an HTML document. FIG. 1 shows a flow including steps 100 to 103.

In this way, by freely selecting a user-defined attribute needed to be displayed, a document content may be displayed in a filtered manner, and finally documents of different formats that only have the displayed content may be generated, thereby achieving the effect of “what you see is what you get”. Meanwhile, since a different attribute tag may be defined by a user for each content of the XAML document in the editor, a marking operation flow of the user is simplified.

For example, for a DITA standard document, a DITA defines an entire set of standards for document writing, and the standards are finally borne through an XAML document. The solution in the embodiment of the present invention provides a DITA file editing environment with the effect of “what you see is what you get”. Therefore, when editing, an author may only need to write the specific content without focusing on the specific DITA standards. Meanwhile, the content is easily filtered through the added user-defined attribute tag. For different customers and different operation systems and others, the same document may demonstrate a document content conforming to a customized requirement.

In another specific embodiment of the present invention, an XML file meeting an ODF specification is converted into a file of an XAML format through a conversion rule. A visual editing environment based on Silverlight may be provided for this type of XML file, and meanwhile, the effect of filtering a marked content may be implemented with reference to an attribute tag. Therefore, for different customers and different operation systems and others, the same document may demonstrate a document content conforming to a customized requirement.

As shown in FIG. 2, it is another specific schematic flowchart of a document processing method according to an embodiment of the present invention, which includes the following steps.

201: Convert an XML file into a source XAML document.

For example, firstly, an XML document is converted into an internationally accepted standard document, such as a DITA document or an OpenXML document, or converted into a user-defined standard document. Then, these documents are converted into XAML documents through a visual editor. An XML file is visually demonstrated in the editor, so as to generate a corresponding document by using a previously defined display standard after subsequent editing is completed. In this way, the editing effect of “what you see is what you get” is achieved.

202: Set attribute tags for the source XAML document, and obtain a target XAML document.

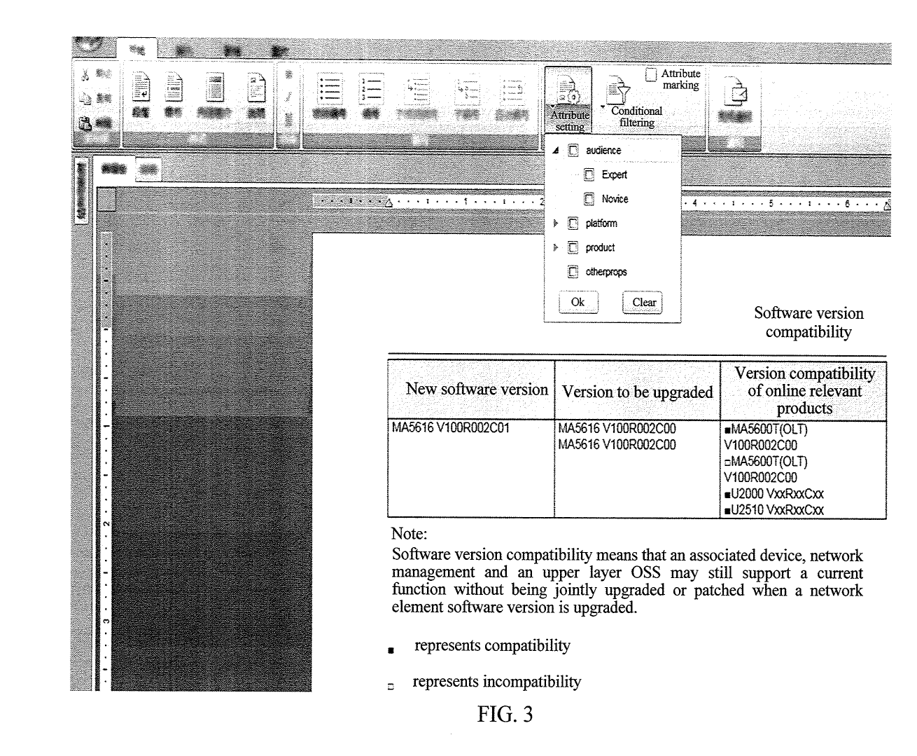

For example, attributes may be rapidly customized/defined by a user in the editor, and any part of a content may be selected for assigning the customized attributes to it. As shown in FIG. 3, it is a schematic diagram of performing marking in the editor.

After attributes are set for a document content, the part of the content set with the attributes may be synchronously marked and displayed in an interface. These attribute tags and the source XAML document are displayed on different layers, so that the attribute tags do not occupy placeholders of the source document, thereby ensuring the effect of “what you see is what you get”. A background XAML document automatically finds the corresponding content and marks the content, and then the target XAML document is obtained.

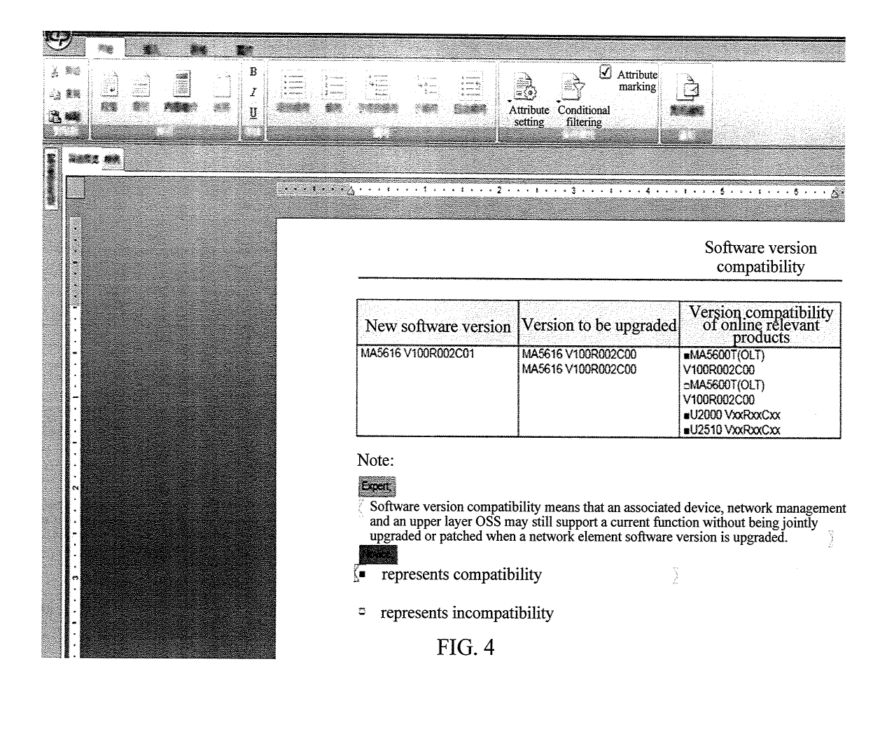

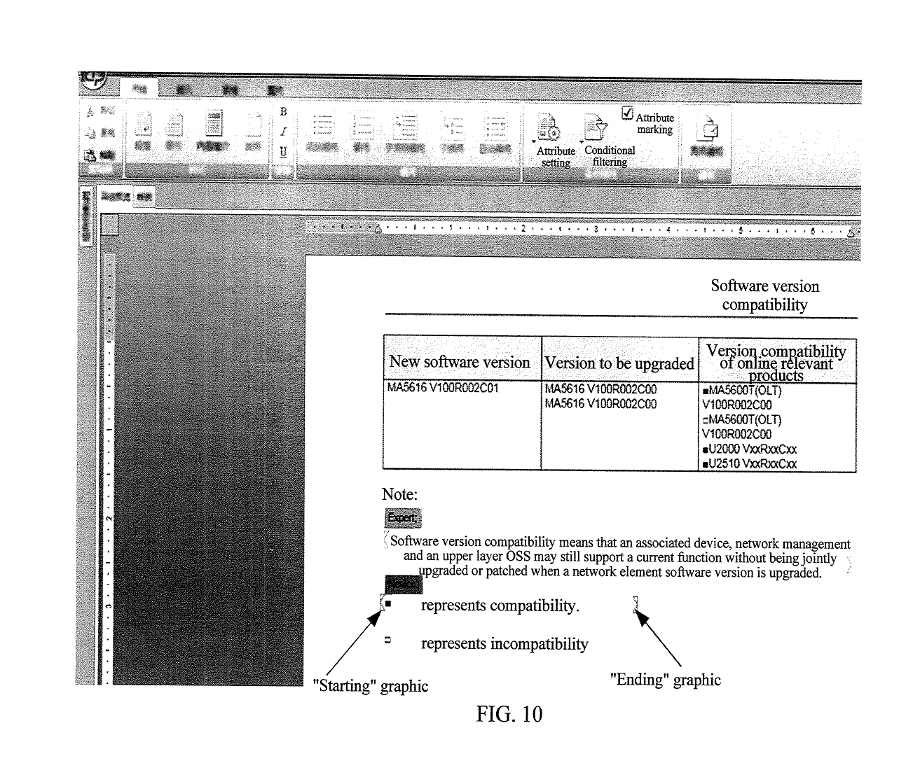

For example, after setting an Expert attribute and a Novice attribute for a document content, the effect of a foreground interface is shown in FIG. 4. As shown by indicators in FIG. 10, a “starting” graphic and an “ending” graphic are corresponding to a front bracket and a rear bracket which are of a light color in the figure, respectively. The content in the brackets is the content with the attribute tag in the document. A shadowed part (that is, a tag) above the content is the attribute tag of the content. In this embodiment, the document has two paragraphs which have different attribute tags, respectively. Surely, in another embodiment, the same paragraph may have a plurality of different attribute tags.

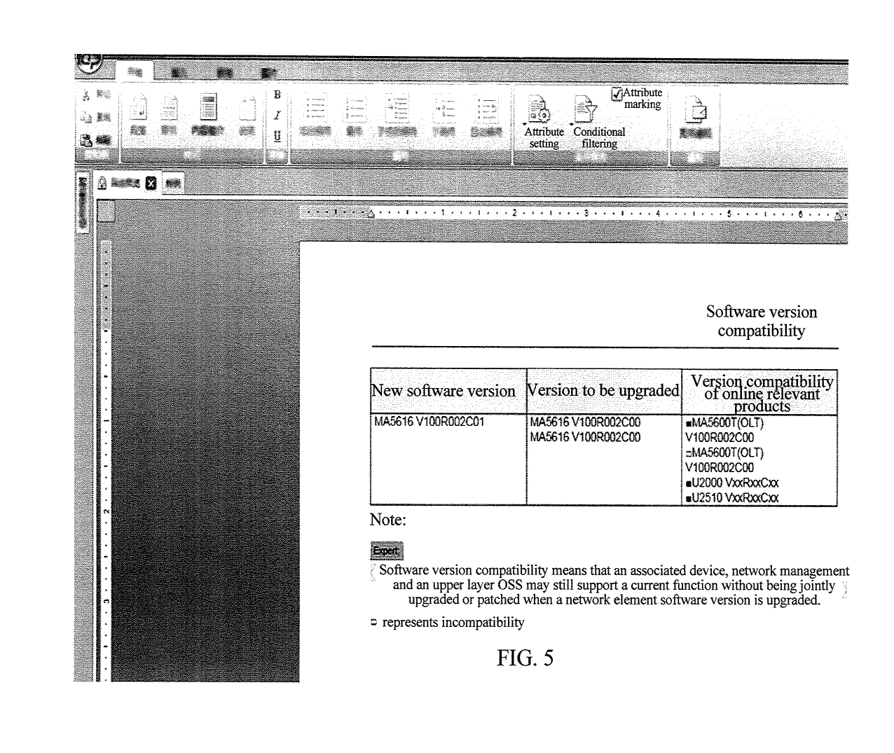

203: Define a filtered display by a user. For example, the filtered display may be implemented according to a requirement by freely combining the contents with the set attributes in the above step (for example, only the “Expert” attribute is displayed, and a display result is shown in FIG. 5).

Correspondingly, an embodiment of the present invention also provides a document editing method. The method includes a step of converting an initial document into a target XAML document, where one or more contents in the target XAML document carry user-defined attribute tags, so that when a filtered display is performed, according to an obtained user-defined attribute tag, only a content with the obtained user-defined attribute tag and a content with no user-defined attribute tag in the target XAML document are displayed.

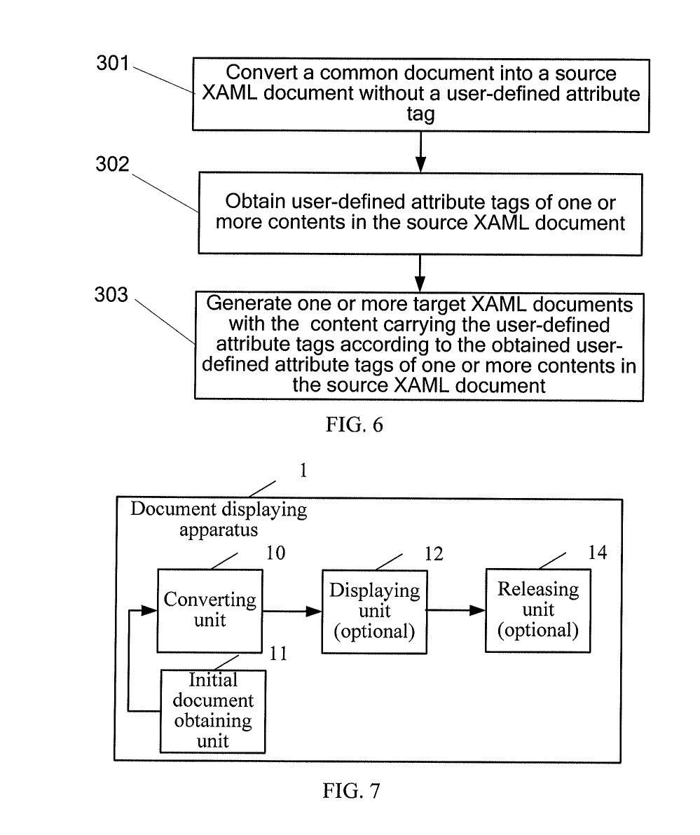

Specifically, as shown in FIG. 6, this step may specifically include the following sub-steps.

301: Convert the initial document into a source XAML document that carries no user-defined attribute tag. The initial document is a DITA standard document, an OpenXML standard document, an ODF standard document or a user-defined standard document. Before this step, a step of converting an XML document into an initial document may further be included.

302: Obtain user-defined attribute tags of one or more contents in the source XAML document.

303: Generate one or more target XAML documents with the content carrying the user-defined attribute tags according to the obtained user-defined attribute tags of one or more contents in the source XAML document. The target XAML document includes the source XAML document and the user-defined attribute tags that do not occupy placeholders of the source XAML document, so that when the target XAML document is displayed, the source XAML document is displayed on a document layer, and the user-defined attribute tags are displayed on a tag layer.

It can be learned from the above description, in the embodiment of the present invention, an attribute may be arbitrarily defined by a user according to a requirement and set in a document. According to a set customized attribute, a document content may be displayed in a filtered manner according to a requirement, and a document of a required content and a required format, for example, a Word document, a PDF document, an HTML document, an HTML help document (HtmlHelp), a Java Help Document (JavaHelp), or a network help document (WebHelp) may be output. The set attribute tags and an original document are displayed on different layers, so that content typesetting of the original document may not be influenced, thereby ensuring the effect of “what you see is what you get” of the output content.

An embodiment of the present invention also provides a document processing apparatus. As shown in FIG. 7, the document processing apparatus 1 includes: an initial document obtaining unit 11, configured to obtain an initial document; and a converting unit 10, configured to convert the initial document into a target XAML document, where the target XAML document at least includes a basic content and an extended content, and the extended content has a plurality of user-defined attribute tags. The user-defined attribute tags do not occupy placeholders of a source XAML document.

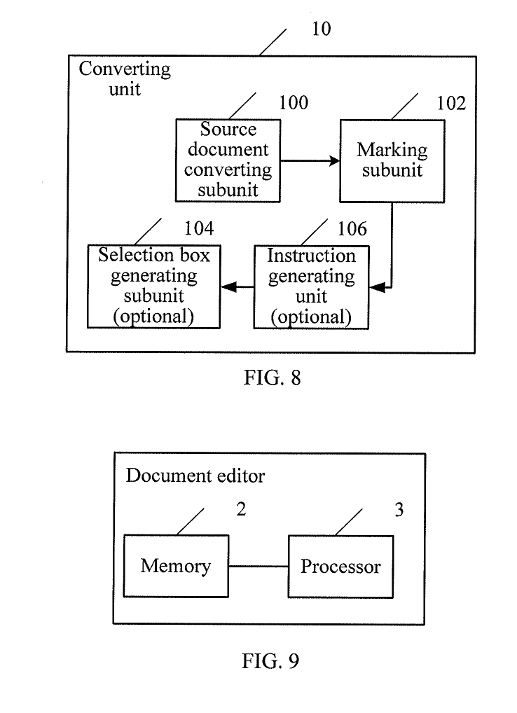

As shown in FIG. 8, the converting unit 10 may include: a source document converting subunit 100, configured to convert the initial document into a source XAML document; a marking subunit 102, configured to receive a content selection instruction and obtain a content attribute tag assignment instruction, select a content of the source XAML document according to the content selection instruction, and according to the content attribute tag assignment instruction, assign user-defined attribute tags to the selected content of the source XAML document to construct the target XAML document, where the user-defined attribute tags are used to mark attributes of the extended content, the selected content of the target XAML document, to which the user-defined attribute tags are assigned, is taken as the extended content, and the rest content is taken as the basic content. Or, the converting unit 10 may further include:

a selection box generating subunit 104, configured to generate a selection box of selectable content attribute tags according to a plurality of preset content attribute tags, and display the plurality of preset content attribute tags in the selection box of content attribute tags; and an instruction generating unit 106, configured to receive a content attribute tag selection instruction, and according to the content attribute tag selection instruction, obtain content attribute tags corresponding to the content attribute tag selection instruction to generate the content attribute tag assignment instruction, where the selection box generating subunit 104 may present the plurality of preset content attribute tags in the selection box of content attribute tags in a hierarchical architecture manner when generating the selection box of selectable content attribute tags.

Further, the apparatus may also include: a displaying unit 12, configured to receive a displayed content selection instruction, and according to a user-defined attribute tag selected according to the displayed content selection instruction, obtain an extended content with the selected user-defined attribute tag, and display the basic content and the extended content with the selected user-defined attribute tag of the target XAML document. Further, the displaying unit is also configured to conceal the user-defined attribute tag of the extended content. That is, during displaying, the user-defined attribute tag is not displayed.

The target XMAL document includes a content displaying layer and an attribute displaying layer. The displaying unit 12 is also configured to display only the basic content and the extended content on the content displaying layer, and display only the user-defined attribute tag on the attribute displaying layer.

Further, the apparatus may also include: a releasing unit 14, configured to fix document formats of the basic content and the extended content with the selected user-defined attribute tag in the target XAML document. As shown in FIG. 7, the three units are all included.

The initial document is a DITA standard document, an OpenXML standard document, an ODF standard document or a user-defined standard document. The target XAML document may include the source XAML document and the user-defined attribute tag that does not occupy a placeholder of the source XAML document. The displaying unit 12 is also configured to display the target XAML document, display the source XAML document on the document layer, and display the user-defined attribute tag on a tag layer.

In specific implementation of the above apparatus, a relevant processing function may be implemented by a processor, and relevant data in a processing procedure may be stored in a memory. For example, the processor converts the initial document into the target XAML document, and stores, in the memory, the target XAML document obtained through the conversion. After receiving a user-defined attribute tag that is input by a user and needs to be displayed, the processor displays the target XAML document according to the obtained user-defined attribute tag. That is, a relevant content is obtained from the memory and is displayed according to the user-defined attribute tag.

As shown in FIG. 9, it is a schematic composition diagram of a document editor according to an embodiment of the present invention. The document editor in this embodiment includes a memory 2 and a processor 3.

The memory 2 is configured to store an initial document. The processor 3 is configured to obtain the initial document, convert the initial document into a target XAML document, and store the target XAML document in the memory, where the target XAML document at least includes a basic content and an extended content, and the extended content has a plurality of user-defined attribute tags.

The processor 3 may be specifically configured to obtain the initial document, convert the initial document into a source XAML document; receive a content selection instruction and obtain a content attribute tag assignment instruction, select a content of the source XAML document according to the content selection instruction, and according to the content attribute tag assignment instruction, assign user-defined attribute tags to the selected content of the source XAML document to construct the target XAML document, where the user-defined attribute tags are used to mark attributes of the extended content, the selected content of the target XAML document, to which the user-defined attribute tags are assigned, is taken as the extended content, and the rest content is taken as the basic content; and store the target XAML document in the memory.

The processor is also configured to generate a selection box of selectable content attribute tags according to a plurality of preset content attribute tags, display the plurality of preset content attribute tags in the selection box of content attribute tags, receive a content attribute tag selection instruction, and according to the content attribute tag selection instruction, obtain content attribute tags corresponding to the content attribute tag selection instruction to generate the content attribute tag assignment instruction.

The plurality of preset content attribute tags is presented in the selection box of content attribute tags in a hierarchical architecture manner. The target XMAL document includes a content displaying layer and an attribute displaying layer. The content displaying layer only displays the basic content and the extended content, and the attribute displaying layer only displays the user-defined attribute tag. The user-defined attribute tag does not occupy placeholders of the source XAML document. The initial document is a DITA standard document, an OpenXML standard document, an ODF standard document or a user-defined standard document. Correspondingly, the document editor may also include a display, configured to display the content displaying layer and/or the attribute displaying layer of the target XAML document.

Further, the processor 3 may also be configured to receive a displayed content selection instruction, and according to a user-defined attribute tag selected according to the displayed content selection instruction, obtain an extended content with the selected user-defined attribute tag. Correspondingly, the document editor also includes a display. The display is configured to display the basic content and the extended content with the selected user-defined attribute tag in the target XAML document.

The processor is also configured to conceal a user-defined attribute tag of the extended content, or configured to fix document formats of the basic content and the extended content with the selected user-defined attribute tag in the target XAML document.

It can be learned from the above description, in the embodiment of the present invention, an attribute tag may be set for any content of the document. One or a combination of the set attribute tags may be arbitrarily selected, thereby displaying the document content in a filtered manner.

Further, in the embodiment of the present invention, a starting graphic image and an ending graphic image are adopted to limit the range of a document content set with an attribute. A user-defined attribute tag is explicitly demonstrated in the form of a tag, and the tag is close to the set content, so as to make an interface of the document concise and clear. The starting and ending graphics for limiting the range and the attribute tag are independent of the document content in the form of a layer, so that they do not occupy the placeholders of the document, so as to achieve the display effect of “what you see is what you get”.

Persons of ordinary skill in the art should understand that all or a part of the steps of the method according to the embodiments may be implemented by a computer program instructing relevant hardware. The program may be stored in a computer readable storage medium. When the program is run, the steps of the method according to the embodiments are performed. The storage medium may be a magnetic disk, an optical disk, a read-only memory (Read-Only Memory, ROM), or a random access memory (Random Access Memory, RAM).

Disclosed above are merely exemplary embodiments of the present invention, but are not intended to limit the scope of the present invention. Therefore, equivalent variations made according to the claims of the present invention shall fall within the scope of the present invention.

What is claimed is:

1. A document processing method, comprising:
obtaining an initial document; and
converting the initial document and forming a target extensible application markup language XAML document, wherein the target XAML document at least comprises a basic content and an extended content, and the extended content has a plurality of user-defined attribute tags.

2. The method according to claim 1, wherein the converting the initial document and forming the target XAML document comprises:
converting the initial document and forming a source XAML document; and
receiving a content selection instruction and obtaining a content attribute tag assignment instruction, selecting a content of the source XAML document according to the content selection instruction, and according to the content attribute tag assignment instruction, assigning the user-defined attribute tags to the selected content of the source XAML document to construct the target XAML document, wherein the user-defined attribute tags are used to mark attributes of the extended content, the selected content of the target XAML document, to which the user-defined attribute tags are assigned, is taken as the extended content, and a rest content is taken as the basic content.

3. The method according to claim 2, wherein the converting the initial document and forming the target XAML document further comprises:
generating a selection box of selectable content attribute tags according to a plurality of preset content attribute tags, and displaying the plurality of preset content attribute tags in the selection box of selectable content attribute tags; and
the obtaining the content attribute tag assignment instruction comprises:
receiving a content attribute tag selection instruction in the selection box of the selectable content attribute tags, and according to the content attribute tag selection instruction, obtaining a content attribute tag corresponding to the content attribute tag selection instruction to generate the content attribute tag assignment instruction.

4. The method according to claim 3, wherein the displaying the plurality of the preset content attribute tags in the selection box of the content attribute tags comprises:
presenting the plurality of the preset content attribute tags in the selection box of the content attribute tags in a hierarchical architecture manner.

5. The method according to claim 2, wherein the user-defined attribute tags do not occupy placeholders of the source XAML document.

6. The method according to claim 1, wherein the target XMAL document comprises a content displaying layer and an attribute displaying layer, the content displaying layer displays the basic content and the extended content, and the attribute displaying layer displays the user-defined attribute tags.

7. The method according to claim 2, further comprising:
receiving a displayed content selection instruction, and according to a user-defined attribute tag selected according to the displayed content selection instruction, obtaining the extended content with the selected user-defined attribute tag; and
displaying the basic content and the extended content with the selected user-defined attribute tag in the target XAML document.

8. The method according to claim 7, further comprising:
concealing the user-defined attribute tag of the extended content.

9. The method according to claim 7, further comprising:
fixing document formats of the basic content and the extended content with the selected user-defined attribute tag in the target XAML document.

10. The method according to claim 1, wherein the initial document is a DITA standard document, an OpenXML standard document, an ODF standard document or a user-defined standard document.

11. A document processing apparatus, comprising:
an initial document obtaining unit, configured to obtain an initial document; and
a converting unit, configured to convert the initial document into a target XAML document, wherein the target XAML document at least comprises a basic content and an extended content, and the extended content has a plurality of user-defined attribute tags.

12. The apparatus according to claim 11, wherein the converting unit comprises:
a source document converting subunit, configured to convert the initial document into a source XAML document; and
a marking subunit, configured to receive a content selection instruction and obtain a content attribute tag assignment instruction, select a content of the source XAML document according to the content selection instruction, and according to the content attribute tag assignment instruction, assign the user-defined attribute tags to the selected content of the source XAML document to construct the target XAML document, wherein the user-defined attribute tags are used to mark attributes of the extended content, the selected content of the target XAML document, to which the user-defined attribute tags are assigned, is taken as the extended content, and a rest content is taken as the basic content.

13. The apparatus according to claim 12, wherein the converting unit further comprises:
a selection box generating subunit, configured to generate a selection box of selectable content attribute tags according to a plurality of preset content attribute tags, and display the plurality of preset content attribute tags in the selection box of selectable content attribute tags; and
an instruction generating unit, configured to receive a content attribute tag selection instruction in the selection box of the selectable content attribute tags, and according to the content attribute tag selection instruction, obtain a content attribute tag corresponding to the content attribute tag selection instruction to generate the content attribute tag assignment instruction.

14. The apparatus according to claim 13, wherein the selection box generating subunit is also configured to present the plurality of the preset content attribute tags in the selection box of the content attribute tags in a hierarchical architecture manner.

15. The apparatus according to claim 12, wherein the target XMAL document comprises a content displaying layer and an attribute displaying layer, the content displaying layer displays the basic content and the extended content, and the attribute displaying layer displays the user-defined attribute tags; and the user-defined attribute tags do not occupy placeholders of the source XAML document.

16. The apparatus according to claim 12, further comprising:
a displaying unit, configured to receive a displayed content selection instruction, and according to a user-defined attribute tag selected according to the displayed content selection instruction, obtain the extended content with the selected user-defined attribute tag, and display the basic content and the extended content with the selected user-defined attribute tag in the target XAML document.

17. The apparatus according to claim 16, wherein the displaying unit is further configured to conceal the user-defined attribute tag of the extended content.

18. The apparatus according to claim 16, further comprising a releasing unit, configured to fix document formats of the basic content and the extended content with the selected user-defined attribute tag in the target XAML document.

19. A document editor, comprising a memory and a processor, wherein the memory is configured to store an initial document; and
the processor is configured to obtain the initial document, convert the initial document into a target XAML document, and store the target XAML document in the memory, wherein the target XAML document at least comprises a basic content and an extended content, and the extended content has a plurality of user-defined attribute tags.

20. The document editor according to claim 19, wherein the processor is specifically configured to:
obtain the initial document;
convert the initial document into a source XAML document;
receive a content selection instruction and obtain a content attribute tag assignment instruction, select a content of the source XAML document according to the content selection instruction, and according to the content attribute tag assignment instruction, assign the user-defined attribute tags to the selected content of the source XAML document to construct the target XAML document, wherein the user-defined attribute tags are used to mark attributes of the extended content, the selected content of the target XAML document, to which the user-defined attribute tags are assigned, is taken as the extended content, and a rest content is taken as the basic content; and
store the target XAML document in the memory.

21. The document editor according to claim 20, wherein the processor is further configured to:
generate a selection box of selectable content attribute tags according to a plurality of preset content attribute tags, and display the plurality of the preset content attribute tags in the selection box of selectable content attribute tags; and
receive a content attribute tag selection instruction in the selection box of the selectable content attribute tags, and according to the content attribute tag selection instruction, obtain a content attribute tag corresponding to the content attribute tag selection instruction to generate the content attribute tag assignment instruction.

22. The document editor according to claim 20, wherein the processor is further configured to:
generate a selection box of selectable content attribute tags according to a plurality of preset content attribute tags, and present the plurality of the preset content attribute tags in the selection box of selectable content attribute tags in a hierarchical architecture manner; and
receive a content attribute tag selection instruction in the selection box of the selectable content attribute tags, and according to the content attribute tag selection instruction, obtain a content attribute tag corresponding to the content attribute tag selection instruction to generate the content attribute tag assignment instruction.

23. The document editor according to claim 19, wherein the target XMAL document comprises a content displaying layer and an attribute displaying layer, the content displaying layer only displays the basic content and the extended content, and the attribute displaying layer only displays the user-defined attribute tags; and
correspondingly, the document editor further comprises a display, configured to display the content displaying layer and/or the attribute displaying layer of the target XAML document.

24. The document editor according to claim 19, wherein the processor is further configured to:
receive a displayed content selection instruction, and according to a user-defined attribute tag selected according to the displayed content selection instruction, obtain the extended content with the selected user-defined attribute tag; and
correspondingly, the document editor further comprises a display, wherein the display is configured to display the basic content and the extended content with the selected user-defined attribute tag in the target XAML document.

25. The document editor according to claim 24, wherein the processor is further configured to:
conceal the user-defined attribute tag of the extended content.

26. The document editor according to claim 24, wherein the processor is further configured to:
fix document formats of the basic content and the extended content with the selected user-defined attribute tag in the target XAML document.
